(19) United States
(12) Patent Application Publication
(10) Pub. No.: US 2003/0017874 A1
(43) Pub. Date: Jan. 23, 2003

(54) Toothbrush with electronic-game apparatus

(76) Inventors: Ye Jianfei, Hangzhou (CN); Nicholas Negroponte, Cambridge, MA (US)

Correspondence Address: YE JIANFEI, ROOM 401, BLDG2, YOUYIXINCUN, SHUGUANG ROAD, HANGZHOU, ZHEJIANG, 310007, CN

(21) Appl. No.: 09/985,697

(22) Filed: Oct. 18, 2001

Related U.S. Application Data
(60) Provisional application No. 60/306,891, filed on Jul. 23, 2001.

(51) Int. Cl. A63F 13/00; A46B 9/04; A46B 15/00

(52) U.S. Cl. 463/46; 15/105; 15/22.1; 15/167.1

(57) ABSTRACT

“Toothbrush with electronic-game apparatus”, as its alias “gamebrush”, has an electronic-gamer combined and turns boring daily tooth-cleaning into charming electronic-games. The toothbrush can detect what time user brush his teeth and for how long, it requests user do tooth-cleaning upon a regular daily timetable, morning and evening, twice a day. A good oral-care habit is the key factor for user to win in the electronic-game. The game model can be vast of kinds. The toothbrush use charming games to “bind” user with a regular daily timetable of tooth-cleaning. It encourages those people without good oral-care habit, especially kids and youngster, brush their teeth regularly. At the meantime, tooth-cleaning history records can be stored in the electronic-game IC chip, so user can check this history record. An advanced model of this toothbrush can communicate with each other and invert its game into multi-player model, another advanced model of this invention allows these toothbrush can speak with each other by voice, for example in a family pack son's toothbrush can speak with dad's toothbrush by voice, just like conversations between real family members. To contact inventor for licensing or other opportunities, please send email to: bizants_jeff@hotmail.com

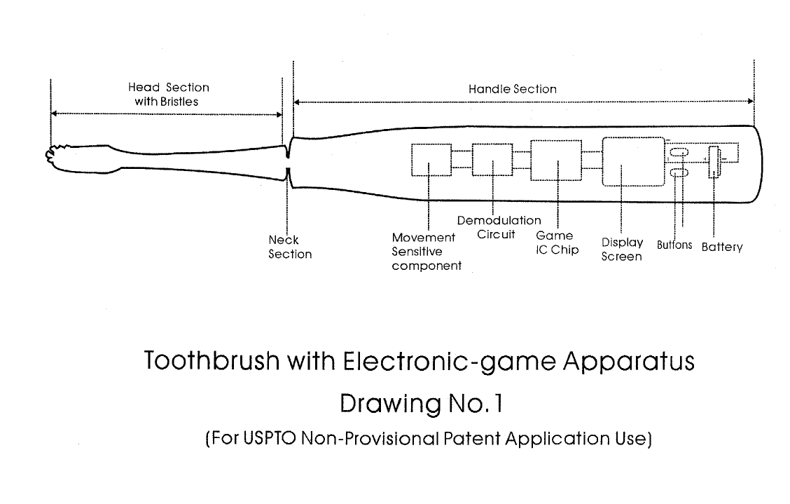

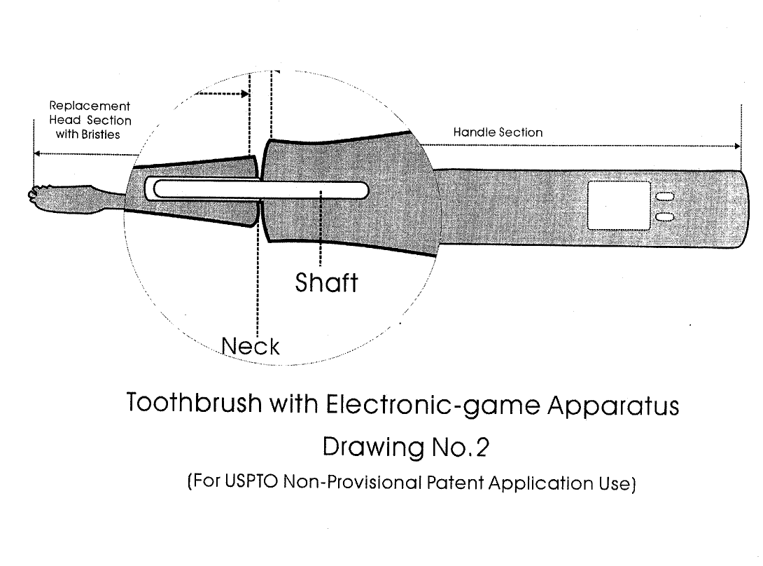

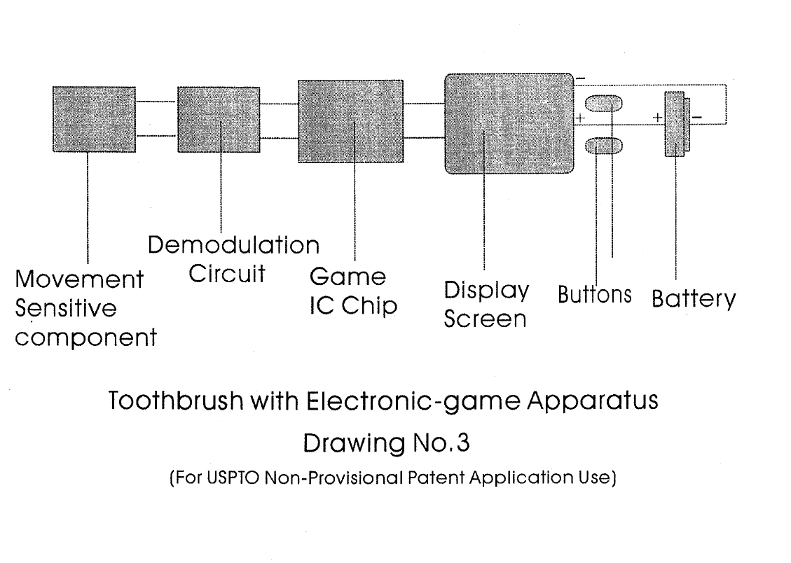

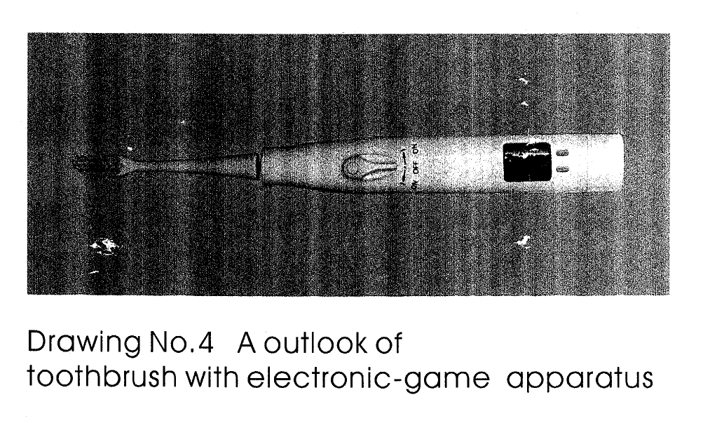

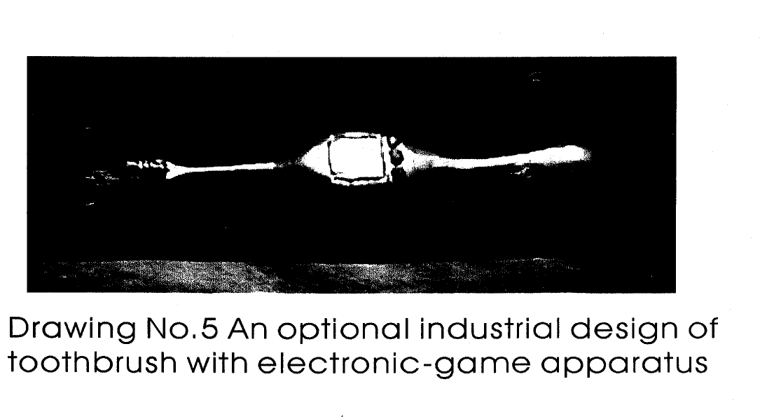

### CROSS-REFERENCE TO RELATED APPLICATIONS

This application claims benefit of U.S. Provisional Patent No. 601306,891, filing/receipt date: Jul. 23, 2001, processing team in USPTO: OIPE titled “Toothbrush with electronic-game apparatus” by inventors Ye Jianfei and Nicholas Negroponte.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of Invention

The invention relates to a toothbrush.

This toothbrush is combined with an electronic-game apparatus, which normally being installed in its handle section. The toothbrush itself can be manual brush or electrical-power brush.

The electronic-game apparatus is consisted by (1) integrated-circuit chip, or called as “IC chip ”, which contains game-program-circuit; (2) displaying screen; (3) external buttons for control and/or settings; (4) micro-speaker for sound and voice; (5) batteries to drive the whole electronic game apparatus; (6) movement-sensitive-component.

The IC-chip drives displaying screen to offer pixel images, to demonstrate electronic game content and game proceeding. The electronic-game apparatus may also send out sound and/or voice by micro-speaker.

The movement-sensitive-component is an alterable electrical resistance or any other component which is sensitive to physical movement and can invert the physical-position-change into the change of electrical-element in circuits (such as electrical current, electrical voltage, etc.). The movement-sensitive-component detects the physical movement of toothbrush body, the movement causes the value of electrical element changed, and eventually reflects to electronic-game IC chip. By this way, this toothbrush will get to know the status of itself when being used, because the user need to shake and/or move the toothbrush body when he does tooth-cleaning. The status of being used which user applies to this toothbrush will effect the game's proceeding.

The external buttons can be used for interfering game proceeding, restarting game, setting time and tooth-cleaning time, and checking tooth-cleaning history records etc.

The head section of toothbrush retains a plurality of toothbrush bristles, can be replaceable after the bristles become scattered, the joint between the head section and the handle section is a metal material shaft, the replaceable head section is easy to plug into and pull out from this metal shaft which is fixed with the handle section. That allows user change the toothbrush head section rather than casting away the whole toothbrush, after the bristles become scattered.

2. Description of the Related Art

“Daily tooth-cleaning is boring!”, to many people it is, even if the dentists will not agree. Specially for many kids and youngsters, they are hard to keep themselves with a regular daily timetable to do tooth-cleaning, or always forget to do tooth-cleaning at the right time. While bad oral-care habit causes a lot of harm to their teeth according to many professional dental-health reports.

Most of the various types of toothbrushes are already known. Traditional manual toothbrush or electrical-power toothbrush is a tool for tooth-cleaning, however they do not bring fun to tooth-cleaning, thus they are not positive to encourage people do tooth-cleaning upon to a regular timetable.

In prior art, some inventions are known to adopt an electronic-beeper which installed in handle section of toothbrush, to sends beeps to remind the user for tooth-cleaning when the cleaning-time comes, this can remind the user do tooth-cleaning, but still can not bring fun to tooth-cleaning.

This invention binds electronic-game apparatus with toothbrush, and binds game proceeding with daily tooth-cleaning behavior. Thus the user of this toothbrush in the meantime is a game player, different usage status which user applies to this toothbrush will cause different game proceeding and eventually lead to different results. While the key factor to win in the game is that user must keep himself with a good oral-care habit, and use this toothbrush do tooth-cleaning upon a regularly daily timetable, morning and evening, twice a day, with sufficient cleaning time at minimum request by dentists.

The game proceeding requests a continuous playing, while the major approach for user to play this game is doing tooth-cleaning. To win the game, the user has to do tooth-cleaning continuously upon a regular daily timetable for tooth-cleaning. Even if he forget to do tooth-cleaning only for one time, he also will lose gaming scores and achievements which spent some days to collect.

Comparing with prior arts, this invention binds electronic-game apparatus with toothbrush, binds game-playing with tooth-cleaning, then as a result it binds emotional fun with rational oral-care behavior. This invention can more efficiently encourage & remind user to do tooth-cleaning in a regular timetable and keep user with a good oral-care habit.

### BRIEF SUMMARY OF THE INVENTION

To a lot of people, keeping tooth-cleaning upon a regular daily timetable is difficult for them, specially to kids and youngsters.

“Toothbrush with electronic-game apparatus” is an invention that relates a new type of toothbrush. This toothbrush combines with an electronic-game apparatus. The electronic-game apparatus provides game for playing, as well as it also contains a movement-sensitive-component which detects the movement of toothbrush when user shakes and/or moves it for tooth-cleaning.

The models of game are of various types, while the status of being used which user applies to this toothbrush will effect electronic-game's proceeding and eventually lead to different results, and the key factor for user to win in the game is to do tooth-cleaning upon a regular daily timetable, to keep himself staying with a good oral-care habit.

This invention turns boring daily tooth-cleaning into charming electronic games, to encourage those people to do tooth-cleaning upon a regular daily timetable, morning and evening, twice a day, eventually helps people raise a good oral-care habit.

This invention has some advanced models which base on said above model.

### BRIEF DESCRIPTION OF THE SEVERAL VIEWS OF THE DRAWING

Drawing 1 The drawing shows the whole structure of this toothbrush, including its every section in whole body of toothbrush.

Drawing 2 The drawing shows the details if the head section with bristles adopts replacement type. As drawing demonstrating, the head section and the handle section are connected via a metal shaft. The metal shaft which is fixed with handle section plugs into the replacement head section, and also easy to be pulled out when the head section is needed for being cast away.

Drawing 3 The drawing shows the relationships among every functional modules. As the drawing demonstrating, the movement-sensitive-component reflects physical movement of toothbrush body to the demodulation circuit by its electrical current change, the demodulation circuit demodulates the waveform and transform them into electronic signals, the electronic-game IC chip makes analysis and adopt effective signal, to interfere the game proceeding.

Drawing 4 The drawing is a computer simulated photo, to show a possible image after this invention becomes a commercial product.

### DETAILED DESCRIPTION OF THE INVENTION

“Toothbrush with electronic-game apparatus” is a new type of toothbrush combining with an electronic-game apparatus. The toothbrush itself can be manual brush or electrical-power brush.

Normally the electronic-game apparatus is in this toothbrush's handle section. The electronic-game apparatus, as we call its alias “gamer”, is consisted by displaying screen, integrated circuit chip (IC chip), external buttons, micro-speaker, batteries and movement-sensitive-component (as its alias “movement-sensor”). The displaying screen normally adopts LCD screen, but also can choose other types of displaying screen; The IC chip contains (1) game-program circuit which process the game proceeding;(2) the related functional circuit for the processing of cleaning-time-setting, game-restarting, external button instructions etc.

A movement-sensitive-component is also included in the whole electronic-game apparatus and connects with game IC chip, it detects the toothbrush body's physical movement when user is using this toothbrush for tooth-cleaning.

The movement-sensitive-component is a kind of alterable electrical component such as alterable electrical resistance or electrical capacitance which is sensitive to physical movement. The physical movement of toothbrush body causes the value of this electrical component changed, sequentially the electrical current via it will change and produce waveforms. The demodulation circuit demodulates the electrical current waveform and output effective electronic-signal to the IC chip.

The IC chip is also in charge of analysis the input signals, not all of signals caused by toothbrush body movement will be granted as tooth-cleaning behavior. In some situations, the toothbrush itself can be physically moved from one place to another place, the movement also will be detected by movement-sensitive-component and invert into electronic-signals to offer to the IC chip. In those situations, the analysis program in the IC chip will not grant it as a tooth-cleaning behavior which user applies to the toothbrush. Only the electronic-signals comes continuously and last more than minimum requested time, then the movement will be granted as an effective tooth-cleaning behavior.

The external buttons are for user-control, cleaning-time-setting, checking cleaning history records, restarting game etc.

The detailed electronic game models are of various types;

A typical game model can be:

A farmer is walking along a road, there are lots of fruit-trees along the road. Every time the user applies the toothbrush to do tooth-cleaning, the farmer moves forward, picking the fruits into his basket, getting bonus scores. However, there are some competitors being after the farmer, the farmer need to run fast to avoid the competitor catch up him and rob the fruits from his basket. —As a key factor of game proceeding, we can see if the user always forget to use this toothbrush to do tooth-cleaning, then the farmer would easily be caught up by rear “competitors” and lost everything in the basket.

As setting forth above, the game models are not limited in a certain scope, the game software program will be installed in the IC chip. A single electronic-game apparatus in the toothbrush may offer multi-games option and users can choose it from option menu by external buttons.

To the user of this toothbrush, the major approach to play this game is doing tooth-cleaning, a good oral-care-habit is the key factor to win the game. Every kind of game will request user do tooth-cleaning twice a day as its proceeding, in morning and evening with minimum-requested duration. If user don't meet these requests as game's proceeding, it will be very hard for him to win in the game. If he doing well, then he can get a high score and win the game eventually. The purpose of this invention is to encourage users do tooth-cleaning regularly, to raise a good dental-heath habit.

As affiliated functions, the electronic-game apparatus can send out sound and/or voice when game is proceeding and/or remind user at the preset time for tooth-cleaning. The electronic-game apparatus also can keep the history records of tooth-cleaning for later checking.

As said above, the toothbrush itself can be manual brush or electrical-power brush. The body of toothbrush includes its head section, neck section and handle section. The head section retains a plurality of toothbrush bristles; the neck section joins the handle section of toothbrush; the handle section is where the game apparatus installed as well as for manual-holding. The handle section has a hollow space for installation of electronic-game apparatus, if it is an electrical-power brush, then this hollow space also will hold related electrical generator apparatus & batteries etc.

The whole toothbrush body can be made of plastic material by plastic molding injection art, or made of other materials and/or mixed with other kinds of different materials such as rubber. If the head section is replaceable, then user can replace old head section by a new one when the brush bristles become scattered after long-term usage. For Joint with a replacement head section, the neck section is a shaft being made of metal or other materials, the shaft fixed with the handle section, to plug into the replacement head section. (see drawing No.2)

However, as another model of toothbrush body, it also can be integral, that means the head section is not replaceable, user casts away the toothbrush as a whole after brush bristles become scattered.

There are some advanced models over said basic model above:

An advanced model of this invention allows these toothbrush communicate with each other and invert its game into multi-players mode.

Another advanced model of this invention allows these toothbrush speak with each other by voice. The voice comes from the micro-speaker of the electronic-game apparatus. For example in a family pack son's toothbrush can speak with dad's toothbrush by voice. Just like those conversations between real family members.

What is claimed is:

1. A toothbrush combining with an electronic-game apparatus. The electronic-game apparatus offers electronic-game for playing. The game's proceeding is demonstrated by image and/or sound and/or voice.
The electronic-game apparatus also contains a movement-sensitive-component so it can detect the body-movement of toothbrush.
Between the toothbrush and the electronic-game apparatus, there MUST be a relevancy as follow:
The status of being used which user applies to this toothbrush for tooth-cleaning will effect the electronic-game's proceeding and eventual lead to different results in the electronic-game apparatus.

2. A toothbrush according to claim 1, wherein the toothbrush itself can be manual toothbrush or electrical power toothbrush.

3. A toothbrush according to claim 1, wherein the head section is replaceable. The head section retaining a plurality of toothbrush bristles, with a shaft joining the handle section of toothbrush. So after the toothbrush's bristles becomes scattered, user can replace the head section by a new one, but remain the other sections of whole toothbrush.

4. A toothbrush according to claim 1, wherein the electronic-game apparatus provides multi-games option, so user can choose the games from the option menu;

5. A toothbrush according to claim 1, wherein the electronic-game apparatus can keep tooth-cleaning history records in its IC chip, as an affiliated function;

6. A toothbrush according to claim 1, wherein the electronic-game apparatus can send out sounds to remind user do tooth-cleaning, as an affiliated function;

7. A toothbrush according to claim 1, wherein the electronic-game apparatus does not physically joint with the toothbrush, but communicated with each other by wireless communication approach such as “blue-teeth” technology;

8. A toothbrush according to claim 1, wherein two or above number of these toothbrushes can communicate with each other, and invert its electronic-game into multi-players mode;

9. A toothbrush according to claim 1, wherein two or above number of these toothbrushes can speak with each other by voice. (i.e. in a family pack of these toothbrushes, son's toothbrush can speak to dad's toothbrush, just as the conversations among real family members.)

10. A toothbrush according to claim 1, wherein the electronic-game apparatus does not physically joint with the toothbrush, but as a bedframe which allows the toothbrush plug into it;
